(19) United States
(12) Patent Application Publication
(10) Pub. No.: US 2001/0012455 A1
(43) Pub. Date: Aug. 9, 2001

(54) Camera stand

(76) Inventors: Timothy G. Mulcahy, Worcester, MA (US); Phillip H. Pritchard SR., Worcester, MA (US)

Correspondence Address: Steven N. Fox, Esq., P.O. Box 251, Canton, MA, 02021, US

(21) Appl. No.: 09/728,892

(22) Filed: Dec. 2, 2000

Related U.S. Application Data
(63) Continuation-in-part of application No. 09/233,349, filed on Jan. 19, 1999, now abandoned.

(51) Int. Cl. G03B 17/00

(52) U.S. Cl. 396/419; 396/428; 396/422

(57) ABSTRACT

The present invention is a camera stand for use by a professional photographer in connection with a camera or a flash unit bracket having the camera mounted thereon. In one embodiment, the camera stand comprises a mounting surface adapted to securely engage with a camera or a corresponding mounting surface of a flash unit bracket having a camera and flash unit mounted thereon. The camera stand further comprises first and second leg members extending downward from the mounting surface. The camera stand further comprises a multi-purpose leg member extending downward from the mounting surface. The multi-purpose leg member comprises an upper portion connected to the mounting surface and a lower portion engageable with a work surface such as a table or desk. The multi-purpose leg member further comprises a hand grip portion positioned substantially below the mounting surface. With the camera stand of the present invention, a professional photographer may place the camera stand on the a work surface to orientate the camera and/or flash unit in a stable upright position during non-use. During use, the professional photographer may hold the hand grip portion to operate the camera and/or flash unit simultaneously with ease, speed, and proficiency.

This application is a continuation-in-part and claims priority to U.S. Application Ser. No. 09/233,349 filed on Jan. 19, 1999.

### BACKGROUND OF THE INVENTION

Professional photographic equipment generally consists of a camera and a flash unit. U.S. Pat. No. 4,752,794 to Bohannon discloses a brackets that can be used by a professional photographer to hold and operate a camera and flash unit. Quite often, however, there is a need for the professional photographer to physically place a camera down to perform other activities such as opening a new roll of film. In such cases, brackets of the type shown in U.S. Pat. No. 4,752,794 are not designed to prevent the camera from damage during such non-use. U.S. Pat. Nos. 3,704,848 to Trebes et al and 5,360,194 to Jacobson each disclose a bracket that allows a professional photographer to mount a camera in an upright position during non-use. Brackets of the type shown in U.S. Pat. Nos. 3,704,848 and 5,360,194 do not allow a professional photographer to hold and operate a camera and flash unit simultaneously with ease, speed, and proficiency.

### OBJECTS OF THE INVENTION

One object of the present invention is to provide a bracket for use by a professional photographer to mount a camera in an upright and stable position on a work surface during non-use or that can be comfortably held and orientated by the professional photographer to operate the camera with ease, speed, and proficiency; and

Another object of the present invention is to provide a bracket for use by a professional photographer to mount both a camera and a flash unit in an upright and stable position on a work surface during non-use or that can be comfortably held and orientated by the professional photographer to operate the camera and flash unit simultaneously with ease, speed, and proficiency.

### SUMMARY OF THE PRESENT INVENTION

The present invention is a camera stand for use by a professional photographer in connection with a camera or a flash unit bracket. In one embodiment, the camera stand comprises a mounting surface adapted to securely engage with a camera or a corresponding mounting surface of a flash unit bracket. The camera stand further comprises first and second leg members extending downward from the mounting surface. The camera stand further comprises a multi-purpose leg member extending downward from the mounting surface. The multi-purpose leg member comprises an upper portion connected to the mounting surface and a lower portion engageable with a work surface such as a table or desk. The multi-purpose leg member further comprises a hand grip portion positioned substantially below the mounting surface. With the camera stand of the present invention, a professional photographer may place the camera stand on the a work surface to orientate the camera and/or flash unit in a stable upright position during non-use. During use, the professional photographer may hold the hand grip portion to operate the camera and/or flash unit simultaneously with ease, speed, and proficiency.

### BRIEF DESCRIPTION OF THE DRAWINGS

The following detailed description of the invention will be better understood with reference to the accompanying drawings in which:

FIG. 1 is a perspective view of a first embodiment of the camera stand of the present invention shown adapted in one use to securely receive a camera;

FIG. 2 is a perspective view of the first embodiment of the camera stand adapted for use and mounting with a flash unit bracket having a camera mounted thereon.

FIG. 3 is a perspective view of the first embodiment of the camera stand;

FIG. 4 is cross-section view of the first embodiment of the camera stand taken along line 4-4 of FIG. 3;

FIG. 5 is a perspective view of the first embodiment of the camera stand showing the upper surface of the hand grip portion inclined relative to the mounting surface of the camera stand;

FIG. 6 is a perspective view of the first embodiment of the camera stand showing the upper surface of the hand grip portion inclined relative to the mounting surface of the camera stand

FIG. 7 is a perspective view of a second embodiment of the camera stand of the present invention;

FIG. 8 is a front elevation view of the second embodiment of the camera stand;

FIG. 9 is a bottom plan view of the second embodiment of the camera stand;

FIG. 10 is a cross section view taken along line 10-10 of FIG. 7;

FIG. 11 is a perspective view of the first embodiment of the camera stand for with and mounted to a flash unit bracket; and

FIG. 12 is a perspective view of the second embodiment of the camera stand for use with and mounted to a flash unit bracket.

### DETAILED DESCRIPTION OF THE PREFERRED EMBODIMENTS

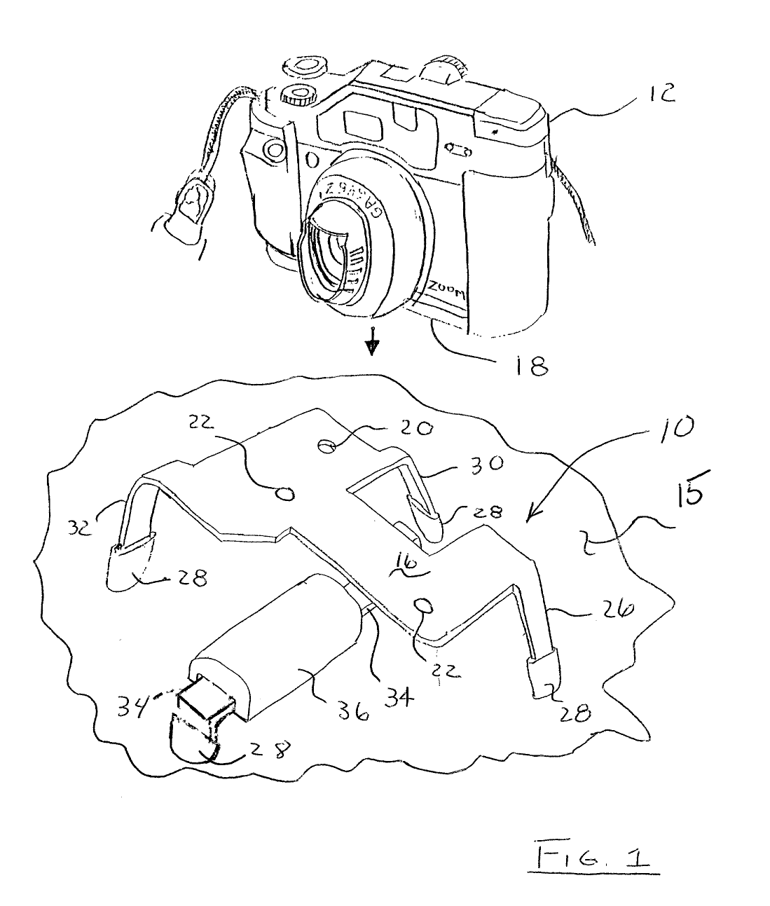

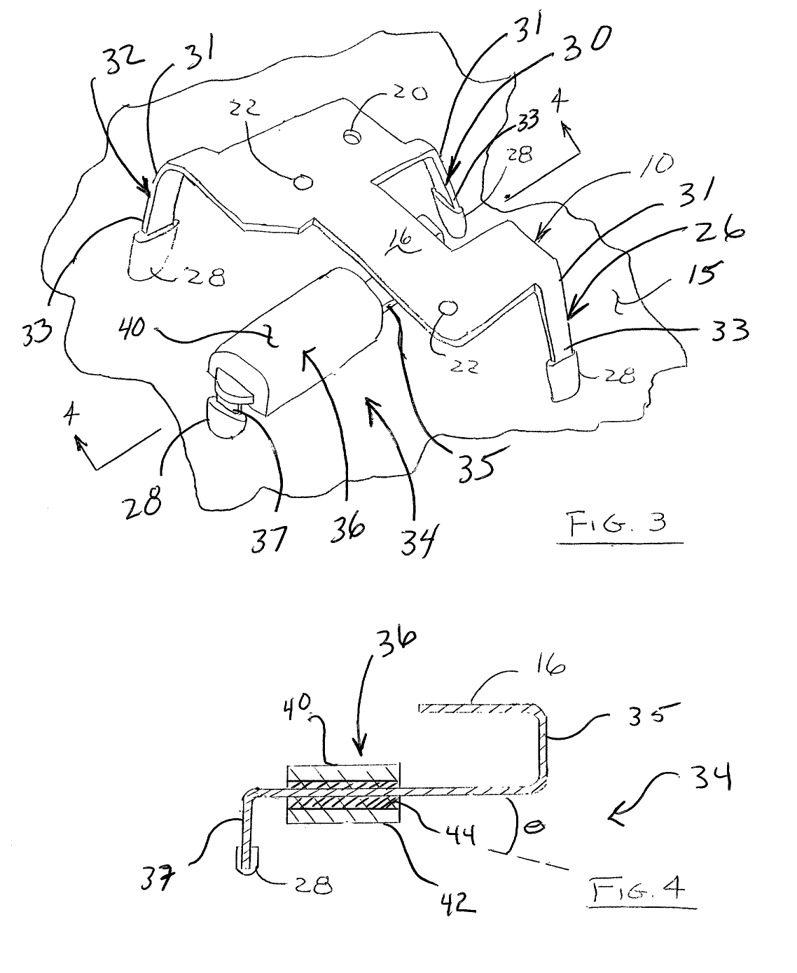

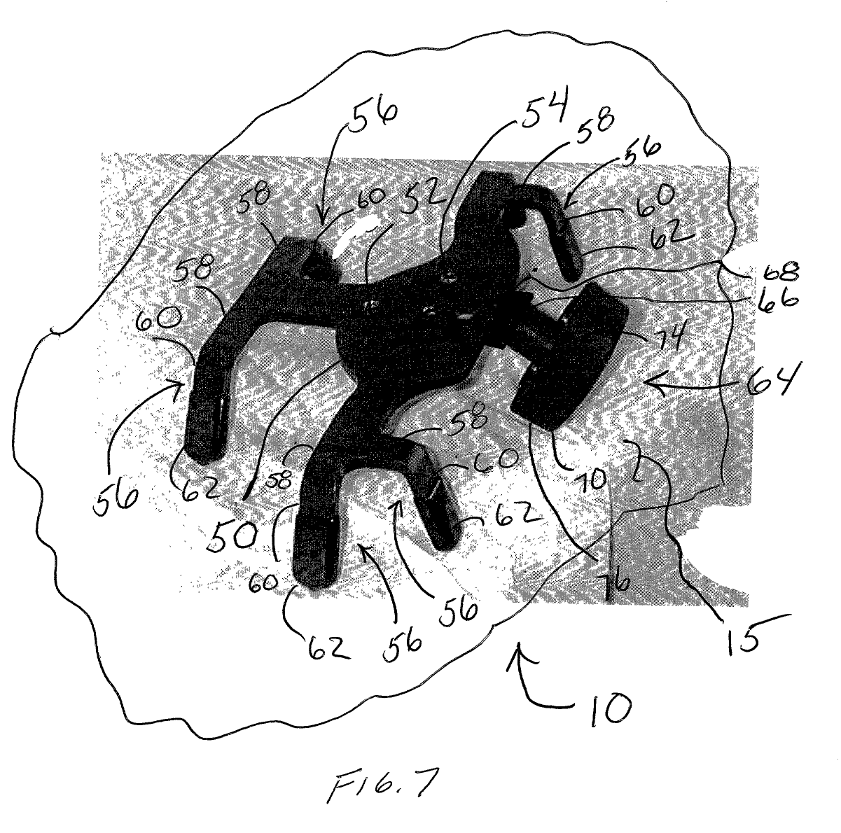

Referring to FIGS. 1-6, wherein the present invention is a camera stand 10 for use by a professional photographer to mount a camera 12 or a flash unit bracket 14 having the camera 12 mounted thereto on the camera stand 10 to thereby position the camera 12 in an upright position on a surface 15 such as a table or desk when non-use of the camera 12 is desired. When use of the camera 12 is desired the professional photographer may comfortably hold and orientate the camera stand 10 to take a desired photograph.

In a first embodiment, the camera stand 10 of the first embodiment generally comprises a mounting surface 16 which is engageable with the camera 12 or the flash unit bracket 14. The mounting surface 16 is provided with an opening 20 to secure the bottom surface 18 of the camera 12 directly to the mounting surface 16 by conventional means such as a screw. The mounting surface 16 is also provided with openings 22 to secure a bottom surface 24 of the flash unit bracket 14 (having the camera 12 mounted thereto) directly to the mounting surface 16 by conventional means such as a screw. The camera stand 10 further comprises leg members 26, 30 and 32, each extending downward from the mounting surface 16. Each of the leg members 26, 30 and 32 have an upper portion 31 connected to the mounting surface 16 and a lower portion 33 in contact with the work surface 15. The lower portion 33 may be provided with an insert or end cover 28 to prevent damage to the work surface 15.

The camera stand 10 further comprises a multi-purpose leg member 34 having an upper portion 35 connected to the mounting surface 16 and a lower portion 37 in contact with the work surface 15. The lower portion 37 may be provided with an insert or end cover 28 to prevent damage to the work surface 15.

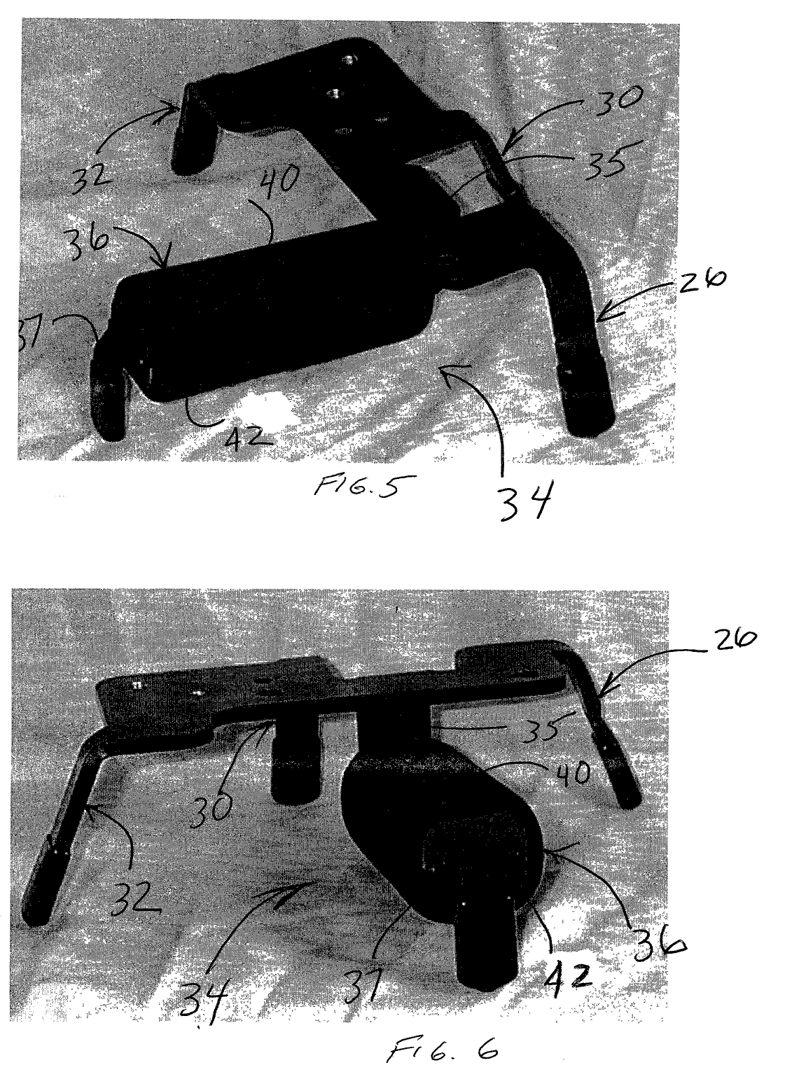

The multi-purpose leg member 34 further comprises a hand grip member or portion 36. The hand grip portion 36 generally comprises upper and lower gripping surfaces 40 and 42 disposed about a rigid insert 44. In the embodiment shown, the upper and lower surfaces 40 and 42 are substantially parallel with the mounting surface 16. As shown in FIGS. 4-6, the upper and lower surfaces 40 and 42 may be inclined an angle relative to the mounting surface 16 to provide a more stable and comfortable grip of the hand grip portion 36.

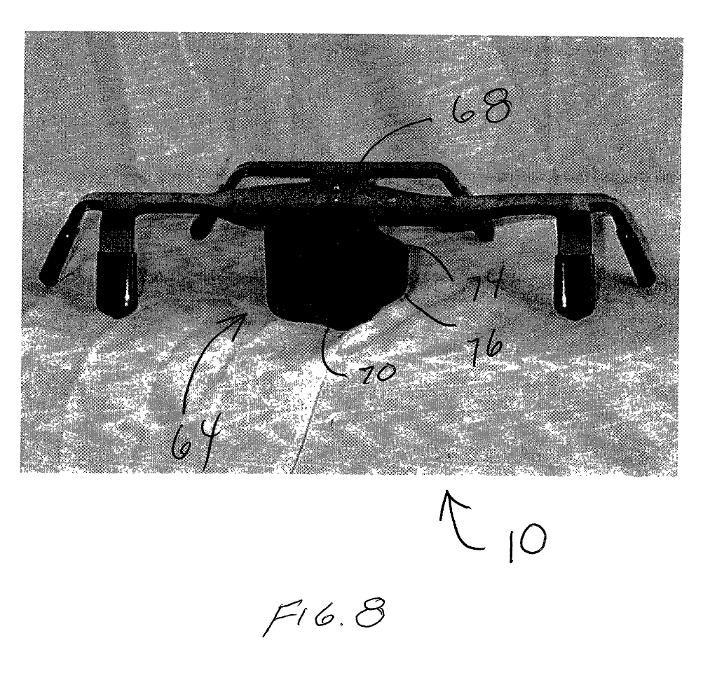

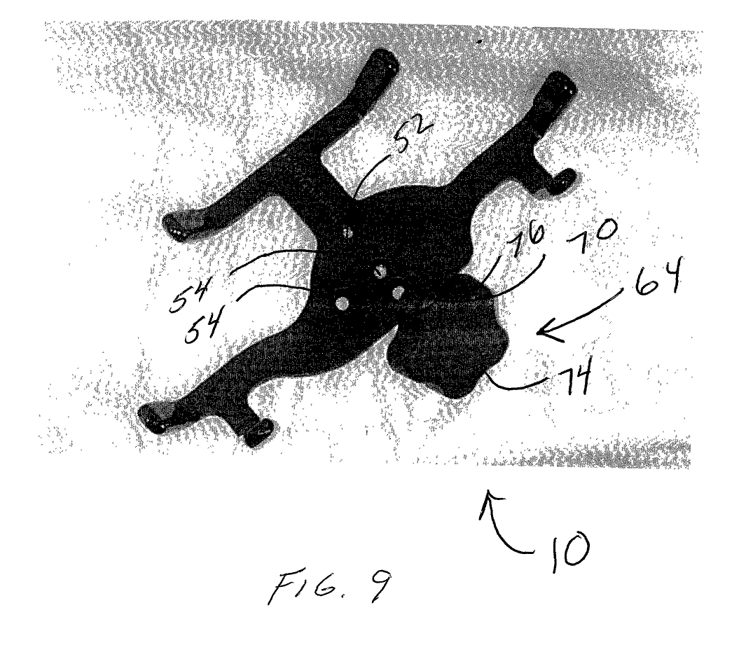

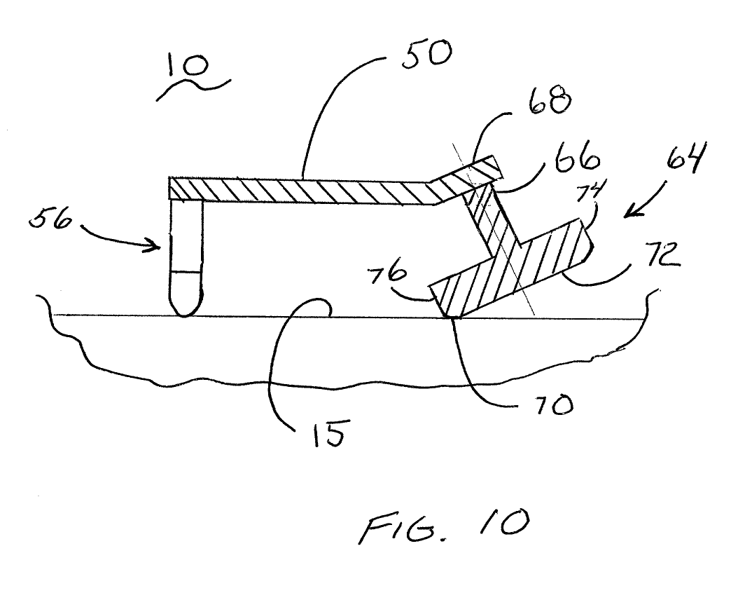

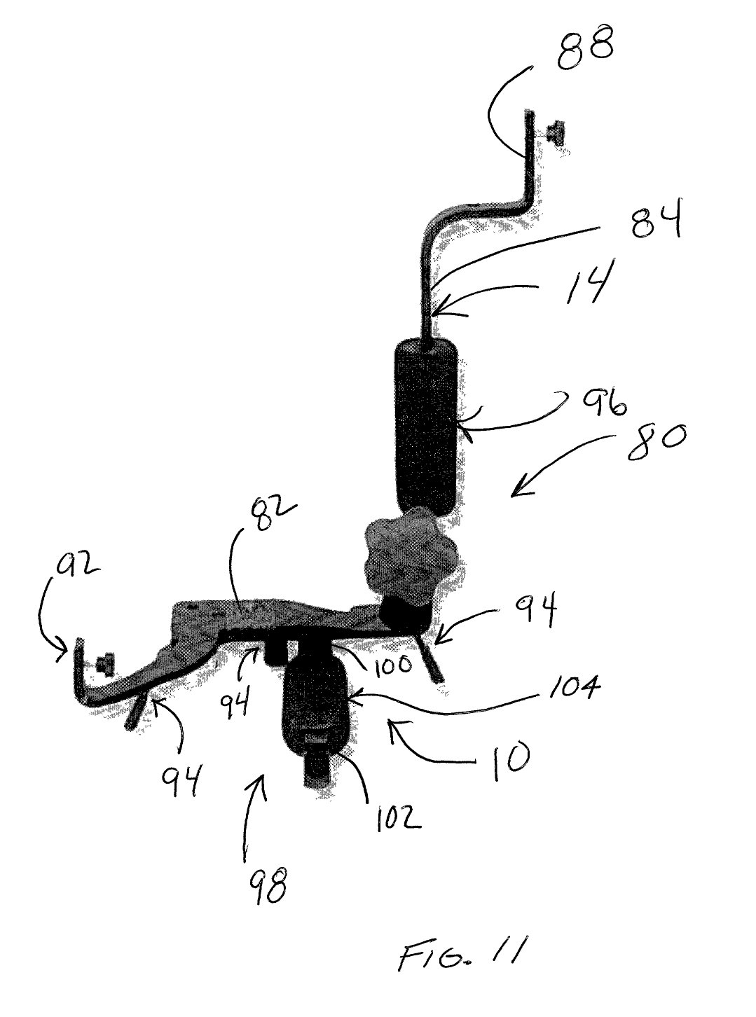

Referring to FIGS. 7-10, where a second embodiment of the camera stand 10 is shown generally comprising a mounting surface 50 which is engageable with the camera 12 or the flash unit bracket 14. The mounting surface 50 is provided with an opening 52 to secure the bottom surface 18 of the camera 12 directly to the mounting surface 16 by conventional means such as a screw. The mounting surface 50 is also provided with openings 54 to secure a bottom surface 24 of the flash unit bracket 14 (having the camera 12 mounted thereto) directly to the mounting surface 16 by conventional means such as a screw. The camera stand 10 further comprises leg members 56 each extending downward from the mounting surface 50. Each of the leg members 56 have an upper portion 58 connected to the mounting surface 50 and a lower portion 60 in contact with the work surface 15. The lower portion 60 may be provided with an insert or end cover 62 to prevent damage to the work surface 15.

The camera stand 10 further comprises a multi-purpose leg member 64 that is generally in the shape of a knob. The multi-purpose leg member 64 generally comprises an upper portion 66 connected to a flange 68 extending from the mounting surface 50 and a lower portion 70 in contact with the work surface 15.

The multi-purpose leg member 64 further comprises a hand grip member or portion 72. The hand grip portion 72 comprises upper and lower gripping surfaces 74 and 76 and a front gripping surface 78. In the embodiment shown, the upper and lower surfaces 74 and 76 are inclined relative to the mounting surface 50 to provide a more stable and comfortable grip of the hand grip portion 72.

The camera stand 10 is adapted to be held by the professional photographer to orientate the camera stand 10 and therefore the camera 12 (or the flash unit bracket 14 having the camera 12 mounted thereon) to take a desired photograph. Unlike conventional devices, the camera stand 10 serves two separate functions: (1) to act as a stand to support the camera 12 (or the flash unit 14 having the camera 12 mounted thereon) in an upright position during non-use and (2) to provide a bracket and handle for supporting and orientating the camera 12 to take a desired photograph. The camera stand 10 is preferably of one-piece unitary construction and is made from a strong, light, and durable material such as aluminum or steel. The camera stand 10 is preferred manufactured by die-cut and bending processes.

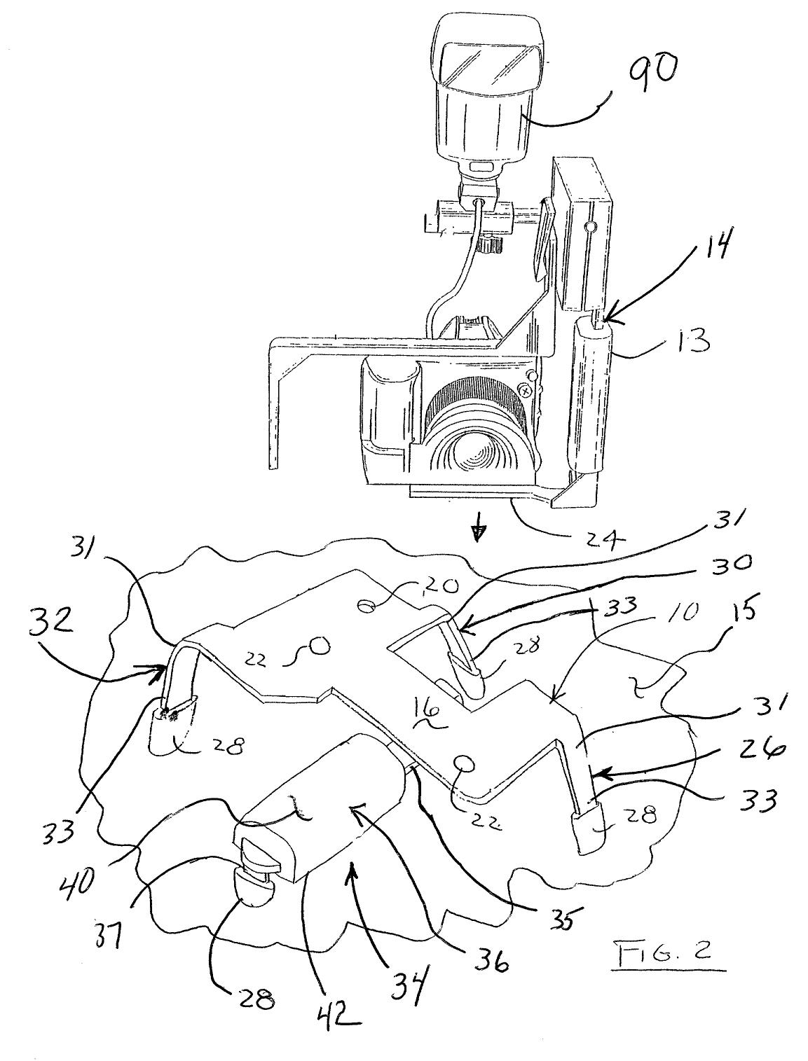

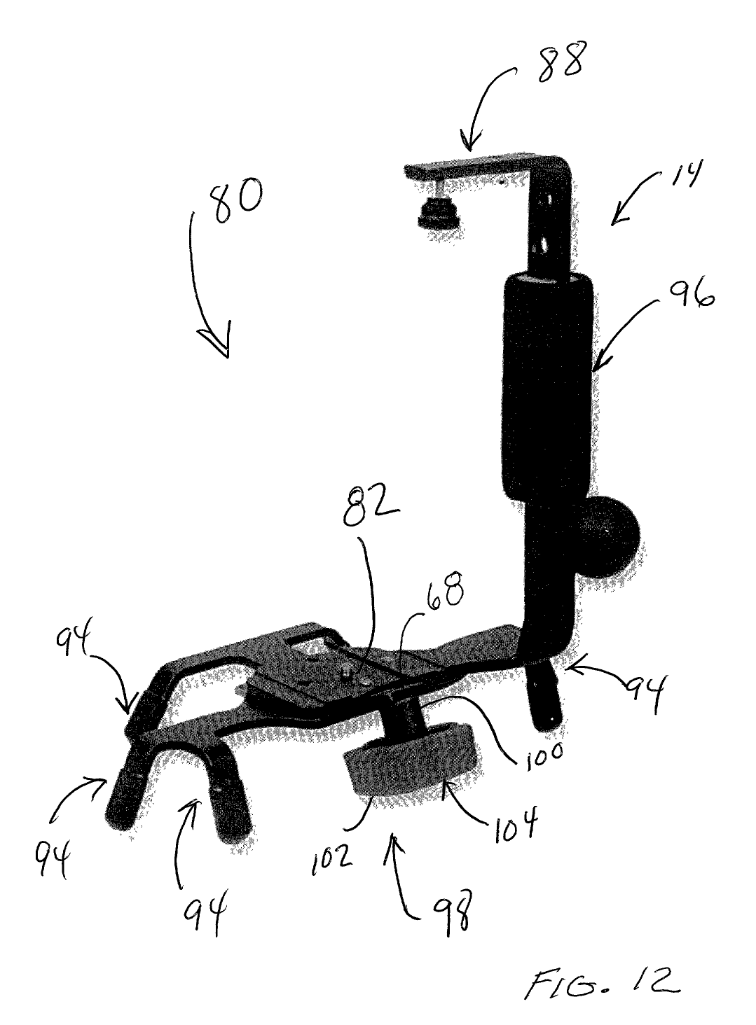

Referring to FIGS. 11 and 12, wherein a bracket assembly 80 is shown generally comprising the first and second embodiments of the camera stand 10 mounted to a flash unit bracket 14. The bracket assembly 80 generally comprises a mounting surface 82 adapted to engage with the camera 12. The bracket assembly 80 further comprise a first support member 84 engaged with the mounting surface 82. The bracket assembly 80 further comprises a first flash unit mounting portion 88 engaged with the support member 84 and adapted to engage with the flash unit 90 (FIG. 2). The bracket assembly 80 further comprises a second flash unit mounting portion 92 engaged with the mounting surface 82 and adapted to engage with the flash unit 90. The bracket assembly 80 further comprises a first hand grip member 96 engaged with the first support member 84 and positioned above the mounting surface 82. The bracket assembly 80 further comprises leg members 94 extending downward from the mounting surface 82. The bracket assembly 80 further comprises a multi-purpose leg member 98 extending downward from the mounting surface 82. The multi-purpose leg member 98 comprises an upper portion 100 engaged with the mounting surface 82 and a lower portion 102 engageable with the work surface 15. The multi-purpose leg member 98 further comprises a second hand grip member 104 positioned substantially below the mounting surface 82.

Although the bracket assembly 80 has been described as having the first and/or second embodiments of the camera stand 10 removably mounted to a flash unit bracket 14, the first and/or second embodiments of the camera stand may integral and unitary to the flash unit bracket 14 and manufactured by bending, machining, and/or welding processes. In such an embodiment, the camera stand would not be removable from the flash unit bracket 14.

The foregoing description is intended for purposes of illustration. The invention may be embodied in other forms or carried out in other ways without departing from the spirit or scope of the invention. Modifications and variations still falling within the spirit or the scope of the invention will be readily apparent to those of skill in the art.

What is claimed is:

1. A camera stand for use by a professional photographer in connection with a camera or a flash unit bracket having the camera mounted thereon, the camera stand comprises:
(a) a mounting surface adapted to engage with the camera;
(b) first and second leg members extending downward from said mounting surface;
(c) a multi-purpose leg member extending downward from said mounting surface, said multi-purpose leg member comprises an upper portion engaged with the mounting surface and a lower portion engageable with the work surface, the multi-purpose leg member further comprises a hand grip portion positioned substantially below said mounting surface; and
(d) whereby the photographer may position the camera in an upright position during non-use and may hold said hand grip portion to orientate the camera for a desired photograph.

2. The camera stand of claim 1, wherein said hand grip portion has an upper surface and a lower surface.

3. The camera stand of claim 2, wherein said upper and lower surfaces of said hand grip portion are inclined relative to said mounting surface.

4. The camera stand of 3, wherein said upper surface of said hand grip portion is substantially parallel to said lower surface of said hand grip portion.

5. The camera stand of claim 4, wherein said upper and lower surfaces of said hand grip portion are each substantially planar.

6. The camera stand of claim 5, wherein said lower surface of said hand grip portion is spaced above the work surface.

7. The camera stand of claim 4, wherein said hand grip portion is in the shape of a knob.

8. A bracket for use by a professional photographer in connection with a camera and a flash unit, the bracket comprises:
(a) a mounting surface adapted to engage with the camera;
(b) a first support member engaged with said mounting surface;
(c) a first flash unit mounting portion engaged with said support member and adapted to engage with the flash unit;
(d) a second flash unit mounting portion engaged with said mounting surface and adapted to engage with the flash unit
(e) a first hand grip member engaged with the first support member and positioned above said mounting surface;
(f) first and second leg members extending downward from said mounting surface;
(g) a multi-purpose leg member extending downward from said mounting surface, said multi-purpose leg member comprises an upper portion engaged with said mounting surface and a lower portion engageable with the work surface, the multi-purpose leg member further comprises a second hand grip member positioned substantially below said mounting surface;
(h) whereby the photographer may position the camera in an upright position during non-use and may grasp said first and/or second hand grip member to orientate the camera for a desired photograph.

9. The camera stand of claim 8, wherein said hand grip member has an upper surface and a lower surface.

10. The camera stand of claim 9, wherein said upper and lower surfaces of said hand grip portion are inclined relative to said mounting surface.

11. The camera stand of 10, wherein said upper surface of said hand grip portion is substantially parallel to said lower surface of said hand grip portion.

12. The camera stand of claim 11, wherein said upper and lower surfaces of said hand grip portion are each substantially planar.

13. The camera stand of claim 12, wherein said lower surface of said hand grip portion is spaced above the work surface.

14. The camera stand of claim 12, wherein said hand grip portion is in the shape of a knob.
